(19) United States
(12) Patent Application Publication
(10) Pub. No.: US 2016/0290524 A1
(43) Pub. Date: Oct. 6, 2016

(54) System for Controlling Valve Positioner

(71) Applicant: Pentair Flow Services AG, Schaffhausen (CH)

(72) Inventor: William Duarte Ferraz, Sertaozinho (BR)

(21) Appl. No.: 15/084,148

(22) Filed: Mar. 29, 2016

Related U.S. Application Data
(60) Provisional application No. 62/142,279, filed on Apr. 2, 2015.

(51) Int. Cl. F16K 31/04; F01D 17/14; F01D 15/10; F16K 37/00; F01D 5/02

(52) U.S. Cl. CPC F16K 31/046; F16K 37/0041; F01D 5/02; F01D 15/10; F01D 17/145

(57) ABSTRACT

Embodiments of the invention provide a system for controlling an analog valve positioner. The system includes a manifold, an analog valve positioner, and a valve actuator. The manifold has a manifold body which houses a spool valve, a powered control valve, and a microturbine generator. The control valve can change the position of the spool valve, and the microturbine generator provides power to the powered control valve. The manifold is in communication with the valve actuator, and the valve actuator is in communication with the analog valve positioner. The manifold also includes a controller, which senses a state of the spool valve and transmits position feedback to the valve actuator.

### RELATED APPLICATIONS

This application claims priority under 35 U.S.C. §119 to U.S. Provisional Patent Application No. 62/142,279 filed on Apr. 2, 2015, the entire contents of which are incorporated herein by reference.

### BACKGROUND

A valve positioner is a device that interfaces with a valve actuator to control a position of a corresponding valve between open and closed positions. Valve positioners are often used to control quarter turn valves in the process industry. For example, valve positioners may be used in chemical processing, oil refineries, or other process industries that include the control of fluid flow. In pneumatic systems, the valve positioner increases or decreases air pressure provided to the valve actuator based on an electronic control signal. The valve positioner is typically coupled to a moving portion of the valve (e.g., a valve stem on a rotating-type valve) so that the valve positioner receives mechanical feedback indicating the valve's position. Conventional systems include manifolds which require tubing and fittings to connect the manifold to the valve positioner or valve controller. Conventional systems also require an external power supply and external electronics to drive the manifold and other components in the system. Valve positioners are often used in systems that must be placed in remote or dangerous areas.

### SUMMARY OF THE INVENTION

It is desirable to provide an improved valve positioner system that provides simpler installation, more flexibility in installation configurations, and improved communication with peripheral systems. In particular, a manifold that allows for wireless transmission of position feedback from a manifold to a valve actuator is desirable. It is also desirable to provide an internal power source that can supplement external power provided to the system.

In some embodiments, the invention provides a system for controlling an analog valve positioner. The system includes a manifold having a manifold body and a cavity, a spool valve disposed within the cavity, a powered control valve disposed within the manifold body and configured to change the position of the spool valve, and a microturbine generator disposed within the manifold body and providing power to the powered control valve. The system also includes an analog valve positioner in communication with the manifold and a valve actuator in communication with the analog valve positioner.

In another embodiment, the invention provides a manifold for a valve actuator. The manifold includes a manifold body, a spool valve disposed within the manifold body and configured to change a state of the valve actuator, a controller disposed within the manifold body and sensing the state of the valve actuator and broadcasting position feedback, and a microturbine generator disposed within the manifold body and providing power to the controller.

### BRIEF DESCRIPTION OF DRAWINGS

FIG. 1 is a schematic view of one embodiment of the invention including a system for controlling an analog valve positioner.

FIG. 2 is a schematic view of another embodiment of the invention including a system for controlling an analog valve positioner.

FIG. 3 is a schematic view of yet another embodiment of the invention including a system for controlling an analog valve positioner.

FIG. 4 is a schematic view of a manifold used in the systems of FIGS. 1-3 for controlling an analog valve positioner.

FIG. 5 is a partial sectional view of a microturbine generator (MTG) for use in the systems of FIGS. 1-3.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

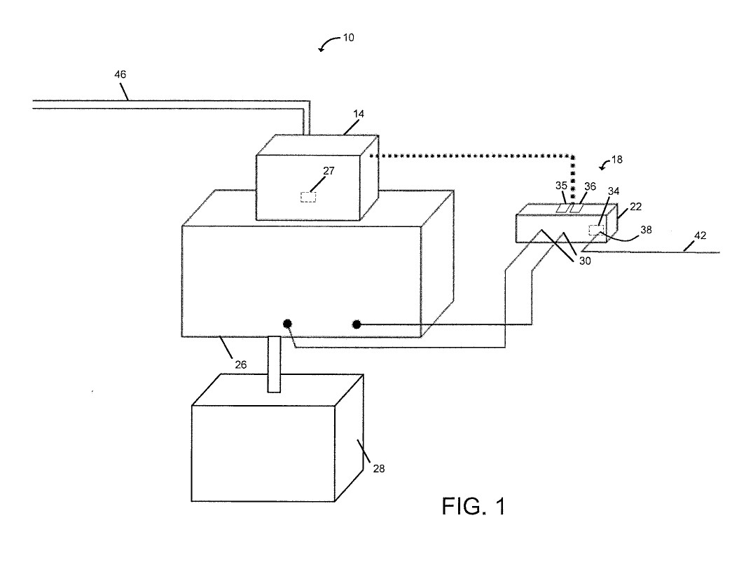

FIG. 1 shows a system 10 according to one embodiment of the invention used for controlling an analog valve positioner 14. The system includes a manifold 18 having a manifold body 22 that provides a housing for a set of manifold components, as will be discussed in detail below. The system 10 also includes a valve actuator 26, which is actuated by the analog valve positioner 14. The analog valve positioner 14 communicates with the manifold 18 and provides signals to the valve actuator 26 that affect how the valve actuator controls a valve 28. In one embodiment, the analog valve positioner 14 receives position information from the manifold 18 and provides a corresponding pneumatic pressure signal to the valve actuator 26. The analog valve positioner 14 includes a position sensor 27 that wirelessly communicates position feedback to the manifold 18. In some embodiments, the position sensor 27 is a resistive potentiometer. In an additional embodiment, the position sensor 27 is a magnetic sensor.

The manifold 18 includes at least one pneumatic connection 30 to the valve actuator 26, a microturbine generator 34, a wireless transmitter 35, and a wireless receiver 36. The pneumatic connections 30 can be connected to the valve actuator 26 with tubing to provide position feedback and/or pneumatic actuation pressure such that the state of the valve actuator 26 is controlled.

The microturbine generator 34 includes an air inlet 38 that receives a flow of air from an air supply 42. The microturbine generator 34 converts the flow of air through the air supply 42 into electronic power and provides that power to the manifold 18. The wireless transmitter 35 and wireless receiver 36 are arranged to wirelessly communicate position data and other information with the analog valve positioner 14.

An external power supply 46 can also be provided to power the analog valve positioner 14, the manifold 18, or the valve actuator 26. The external power supply can be a mains power line, such as a 120 VAC connection or a 240 VAC connection. In the embodiment shown in FIG. 1, the external power supply 46 connects to the analog valve positioner 14. In other embodiments, the external power supply connects directly to the manifold 18 and acts in coordination with the microturbine generator 34 to provide power to the system 10.

In the embodiment shown in FIG. 1, the valve actuator 26 and analog valve positioner 14 are placed in a remote or classified area, and repairs to the manifold 18 may be made away from the valve actuator 26. In other words, the manifold 18 is isolated from the valve actuator 26. This arrangement may be useful in restricted areas of oil refineries, chemical processing plants, or other restricted areas of processing plants.

The system 10 of FIG. 1 operates the valve 28 by coordinating the actions and communication of the analog valve actuator 14, the manifold 18, and the valve actuator 26. A position of the valve is communicated from the analog valve positioner 14 to the manifold 18 wirelessly, the position is interpreted by the manifold 18, and a corresponding pneumatic signal is sent through the pneumatic connections 30 to the valve actuator 26. Based on the communication between the analog valve positioner 14 and the manifold 18, the pneumatic pressure provided to the valve actuator 26 is altered and affects the position of the valve. Power is provided to the system 10 in parallel from both the air supply 42 and the external power supply 46.

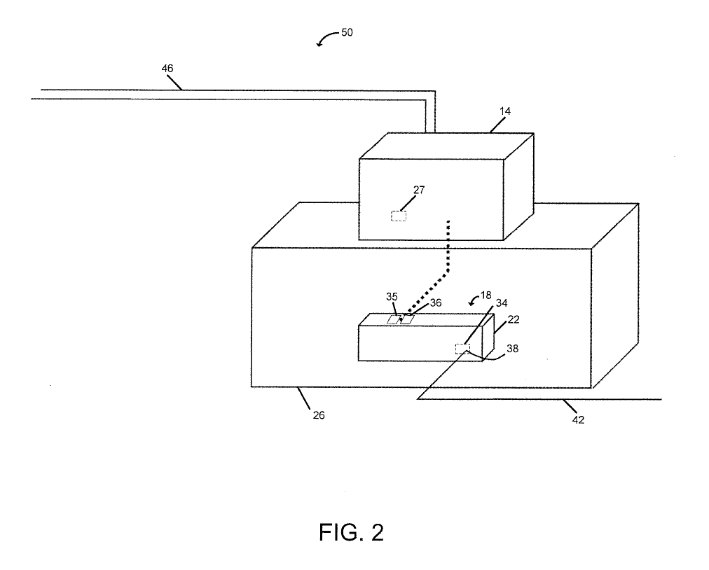

FIG. 2 shows a system 50 that utilizes the same analog valve positioner 14, manifold 18, and valve actuator 26 discussed above but is arranged differently. The system 50 eliminates the tubing used to connect the pneumatic connections 30 to the valve actuator 26 and instead couples the manifold 18 directly to the valve actuator 26 so that the pneumatic connections 30 are directly connected to the valve actuator 26. This type of arrangement is advantageous where the system 50 can be accessed safely or is not particularly remote. Routine repairs to the valve actuator 26 and the manifold 18 can be made in the field where the valve actuator 26 is located. Alternatively, the system 50 can be arranged with the pneumatic connections 30 fully plugged, and the system can rely purely on the position sensor 27 in the analog valve positioner 14 for position feedback. The position data is communicated wirelessly between the manifold 18 and the analog valve positioner 14.

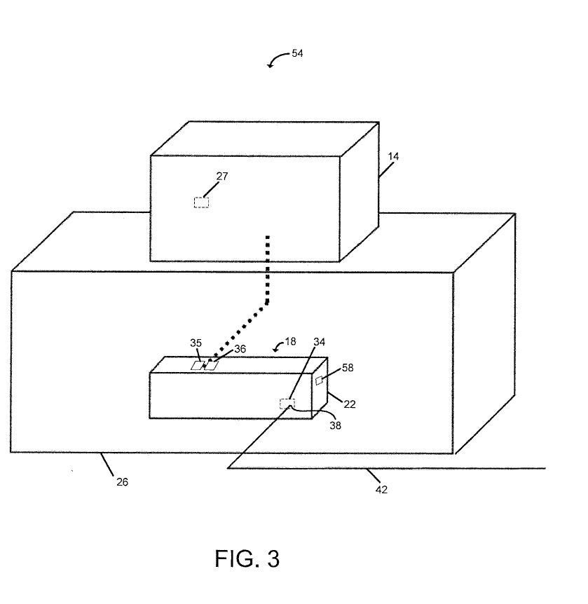

FIG. 3 shows another system 54 that utilizes the same analog valve positioner 14, manifold 18, and valve actuator 26 discussed above but is arranged differently. The external power supply 46 is eliminated and replaced by a battery 58 disposed within the manifold body 22. It is also possible for both the external power supply 46 and the battery 58 to provide external power to the system 54. The system 54 utilizing the battery 58 can be particularly advantageous in remote installations that do not have safety of clearance issues. For example, in locations that do not have a convenient mains power supply (e.g., a remote part of an oil refinery), the battery 58 and microturbine generator 34 can provide long-term operation life and power-supply redundancy.

Individual features of the systems 10, 50, 54 described above can be combined to form other desirable configurations. For example, the system 10 illustrated in FIG. 1 can include a battery 58, or any of the systems 10, 50, 54 can utilize or eliminate the pneumatic connections 30 and the resulting communication with the valve actuator 26.

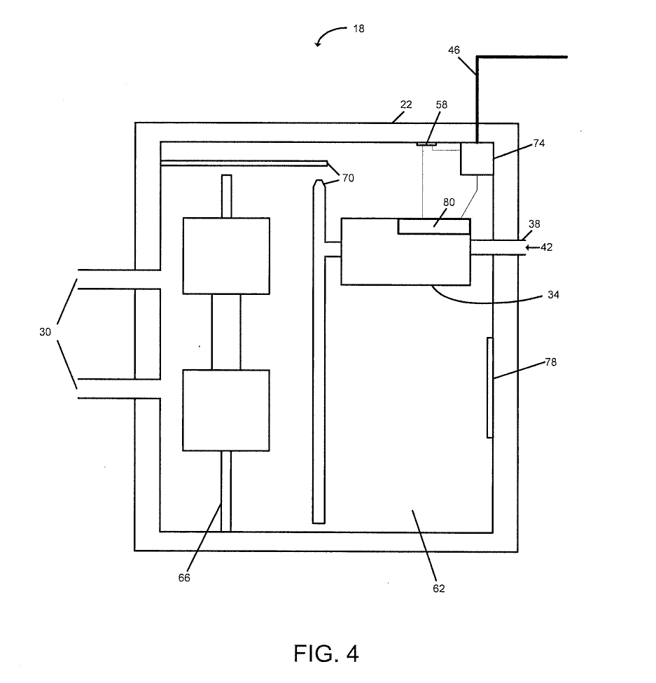

FIG. 4 shows one embodiment of a manifold 18 for use in embodiments of the invention. The manifold body 22 includes a cavity 62 formed to hold a spool valve 66, a powered control valve 70, the microturbine generator 34, the battery 58, an electronic control unit 74, and a controller 78. The spool valve 66 is arranged in communication with and controls flow through the pneumatic connections 30.

The powered control valve 70 shown in FIG. 4 is a flapper-nozzle valve. In other embodiments, the powered control valve 70 can be a piezoelectric valve or another type of valve or actuator. The powered control valve 70 is configured to change the position of the spool valve 66, and therefore is positioned near the spool valve 66 to allow for desired control.

The microturbine generator 34 includes a DC generator 80 that provides power to the powered control valve 70, the electronic control unit 74, and the controller 78. The microturbine generator 34 can be disposed within the cavity 62 holding the spool valve 66, an additional or separate cavity, or housed together with the powered control valve 70 apart from the other manifold components.

As shown in FIG. 4, the electronic control unit 74 controls and communicates with the microturbine generator 34, the external power supply 46, the battery 58, the powered control valve 70, and the controller 78 and regulates power supplied from and to the various components of the manifold 18 and/or larger system 10, 50, 54. In other words, the electronic control unit 74 coordinates the parallel power sources (e.g., the battery 58, the external power supply 46, and the microturbine generator 34) to ensure that all the components of the manifold 18 operate properly and consistently. Additionally, the electronic control unit 74 can utilize the power generated by the microturbine generator 34 to recharge the battery 58 if additional power is available. The electronic control unit 74 can be designed so that the power provided is below a pre-determined limit, allowing for the manifold 18 to be implemented within classified or remote areas. In some embodiments, the power provided by the electronic control unit 74 is monitored to ensure the power does not exceed the pre-determined limit. In one example, the power provided is kept below 40 mW to satisfy requirements when the manifold 18 is used in a classified area of a processing plant, oil refinery, chemical plant, etc.

In some embodiments, the electronic control unit 74 is integral with the manifold 18. It is possible for the electronic control unit 74 to be disposed within the manifold body 22 or joined to an outer wall of the manifold body 22. In other embodiments, the electronic control unit 74 is isolated from the manifold body 22.

The controller 78 disposed within the manifold body 22 receives position information from the analog valve positioner 14 and broadcasts position feedback to the valve actuator 26. In other words, the controller 78 is responsible for the coordination between the analog valve positioner 14 and the valve actuator 26. The inclusion of the controller 78 onboard the manifold 18 allows the manifold to be coupled to an existing analog valve positioner 14 and valve actuator 26 systems, providing upgraded communication and functionality without the need to replace the analog valve positioner 14 or the valve actuator 26.

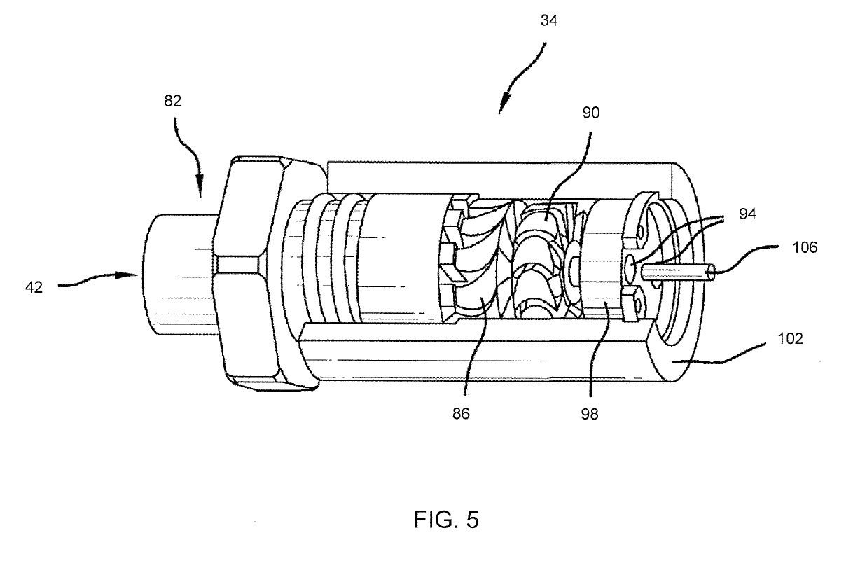

FIG. 5 illustrates one embodiment of a microturbine generator 34 for use with various embodiments of the invention. The microturbine generator 34 operates to convert energy from the compressed air supply 42 into rotational motion, which in turn, rotates a shaft 106 that can be connected to a small DC motor. Air from the compressed air supply 42 enters the microturbine generator 34 via a pneumatic connector 82 and expands over a set of stationary nozzles 86, where it is deflected in a direction tangential to a turbine rotor 90. After the air passes the rotor 90, it leaves through openings 94 in an outlet disc 98. A housing 102 contains the stationary nozzles 86, the rotor 90, and the outlet disc 98. The shaft 106 transmits the rotational motion of the turbine rotor 90 to a DC generator 80, as shown in FIG. 4. In one embodiment, the housing 102 has a diameter of about 15 millimeters (mm) and a length of about 25 mm. The microturbine generator 34 is described in greater detail in Jan Peirs, Dominiek et al, “A Microturbine for Electric Power Generation”-MME'02, The 13th Micromechanics Europe Workshop, Oct. 6-8, 2002, Sinaia, Romania, the entirety of which publication is incorporated herein by reference. In an alternative embodiment, a simplified microturbine generator 34 can includes a small turbine blade or propeller attached to a shaft of a brushless DC motor.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A system for controlling an analog valve positioner, the system comprising:
a manifold including
a manifold body having a cavity,
a spool valve disposed within the cavity,
a powered control valve disposed within the manifold body and configured to change the position of the spool valve, and
a microturbine generator disposed within the manifold body and providing power to the powered control valve;
a valve actuator in communication with the manifold; and
an analog valve positioner in communication with the valve actuator.

2. The system of claim 1, further comprising an external power supply, the manifold receiving power from both the external power supply and the microturbine generator.

3. The system of claim 2, wherein the external power supply is a mains power supply.

4. The system of claim 2, wherein the manifold receives power from either one of the external power supply and the microturbine generator, or both of the external power supply and the microturbine generator.

5. The system of claim 1, further including an electronic control unit that receives power from the microturbine generator and provides power to the powered control valve.

6. The system of claim 1, wherein the total power provided by the electronic control unit is less than 40 mW.

7. The system of claim 1, wherein the manifold further includes a battery disposed within the manifold body.

8. The system of claim 7, wherein the battery receives power from the microturbine generator and provides power to the powered control valve.

9. The system of claim 1, wherein the manifold further includes a wireless transmitter.

10. The system of claim 9, wherein the valve actuator is in communication with the wireless transmitter.

11. A manifold for a valve actuator, the manifold comprising:
a manifold body;
a spool valve disposed within the manifold body and configured to change a state of the valve actuator;
a controller disposed within the manifold body and configured to sense the state of the valve actuator and transmit position feedback; and
a microturbine generator disposed within the manifold body to provide power to the controller.

12. The manifold of claim 11, further comprising an electronic control unit configured to provide power to the controller and receive power from the microturbine generator.

13. The manifold of claim 11, further comprising a battery configured to provide power to the controller.

14. The manifold of claim 11, further comprising a pneumatic connection to the valve actuator.

15. The manifold of claim 11, further comprising an inlet configured to receive an air supply.

16. The manifold of claim 15, wherein the microturbine generator provides power by converting the air supply to a current.

17. The manifold of claim 11, wherein the manifold body is fixed to the valve actuator.

18. The manifold of claim 11, wherein the manifold is configured to receive power from an external power supply.

19. The manifold of claim 11, further comprising a wireless transmitter configured to communicate with a valve positioner.

20. The manifold of claim 11, further comprising an electronic control unit that utilizes power supplied from the microturbine generator, and one of a battery and an external power supply.
